(19) United States
(12) Patent Application Publication
(10) Pub. No.: US 2008/0239552 A1
(43) Pub. Date: Oct. 2, 2008

(54) INFORMATION PROCESSING APPARATUS

(75) Inventor: Akihiro KIMURA, Akishima-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/045,396

(22) Filed: Mar. 10, 2008

(30) Foreign Application Priority Data
Mar. 30, 2007 (JP) 2007-091657

(51) Int. Cl. G11B 21/02

(52) U.S. Cl. 360/75

(57) ABSTRACT

According to one embodiment, an information processing apparatus includes a disk-shaped recording medium, a drive section which rotates the recording medium, a head which records and reproduces information to and from the recording medium, a nonvolatile main memory which stores data in the recording medium, a memory mounting section in which a nonvolatile expansion memory is detachably mountable from outside, and a control section which reads data equivalent to a memory capacity of the expansion memory from the recording medium and writes the data to the expansion memory when the expansion memory is mounted in the memory mounting section.

### CROSS-REFERENCE TO RELATED APPLICATIONS

This application is based upon and claims the benefit of priority from Japanese Patent Application No. 2007-091657, filed Mar. 30, 2007, the entire contents of which are incorporated herein by reference.

### BACKGROUND

1. Field

One embodiment of the present invention relates to an embodiment of the invention relates to an information processing apparatus, such as a magnetic disk device, semiconductor drive, etc.

2. Description of the Related Art

In recent years, information processing apparatuses, such as magnetic disk devices, have been widely used as external recording devices of computers or image recording apparatuses. Further, a semiconductor drive (solid-state drive [SSD]), such as a flash memory drive, has been developed as an alternative information processing apparatus.

For example, a hard disk drive (HDD) is generally provided with a magnetic disk, spindle motor, head actuator, voice coil motor (VCM), circuit board unit, etc. The magnetic disk is disposed in a case. The spindle motor supports and rotates the disk. The head actuator supports a magnetic head. A printed circuit board on which various electronic components, such as a CPU, are mounted is provided on the reverse side of the case. As described in Jpn. Pat. Appln. KOKAI Publication No. 10-307686, for example, there is provided an HDD that includes a nonvolatile memory, which is previously stored with the frequency of data input, frequency of error correction, etc., so that the stored values can be utilized for the determination of the timing for data backup or disk drive replacement.

A so-called hybrid HDD has recently become a noticeable item that combines an HDD and a flash memory, which is a nonvolatile semiconductor memory. If the flash memory of this hybrid HDD is used as a cache memory, the system starting time and the time for recovery from a sleep state can be shortened, the power consumption can be reduced by optimizing an operation mode based on a battery, and the life of the HDD can be lengthened. Thus, the reliability and durability of the HDD can be improved.

Even in the case of the hybrid HDD or SSD described above, however, the memory capacity of the nonvolatile memory is limited, so that there is a demand for higher-speed processing and increased memory capacities.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view showing an HDD according to a first embodiment of the invention;

FIG. 2 is an exemplary plan view showing a memory slot of the HDD;

FIG. 3 is an exemplary exploded perspective view showing the HDD with its top cover off;

FIG. 4 is an exemplary perspective view showing the reverse side of the HDD;

FIG. 5 is an exemplary block diagram schematically showing a general configuration of the HDD;

FIG. 6 is an exemplary diagram typically showing the memory capacity of the HDD;

FIG. 7 is an exemplary flowchart showing the operation of the HDD;

FIG. 8 is an exemplary perspective view showing an SSD according to a second embodiment of the invention; and

FIG. 9 is an exemplary flowchart showing the operation of the SSD.

### DETAILED DESCRIPTION

Various embodiments according to the invention will be described hereinafter with reference to the accompanying drawings. In general, according to one embodiment of the invention, there is provided an information processing apparatus comprising: a disk-shaped recording medium; a drive section which rotates the recording medium; a head which records and reproduces information to and from the recording medium; a nonvolatile main memory which stores data in the recording medium; a memory mounting section in which a nonvolatile expansion memory is detachably mountable from outside; and a control section which reads data equivalent to a memory capacity of the expansion memory from the recording medium and writes the data to the expansion memory when the expansion memory is mounted in the memory mounting section.

A first embodiment in which this invention is applied to a hybrid hard disk drive (HDD) for use as an information processing apparatus will now be described in detail with reference to the accompanying drawings.

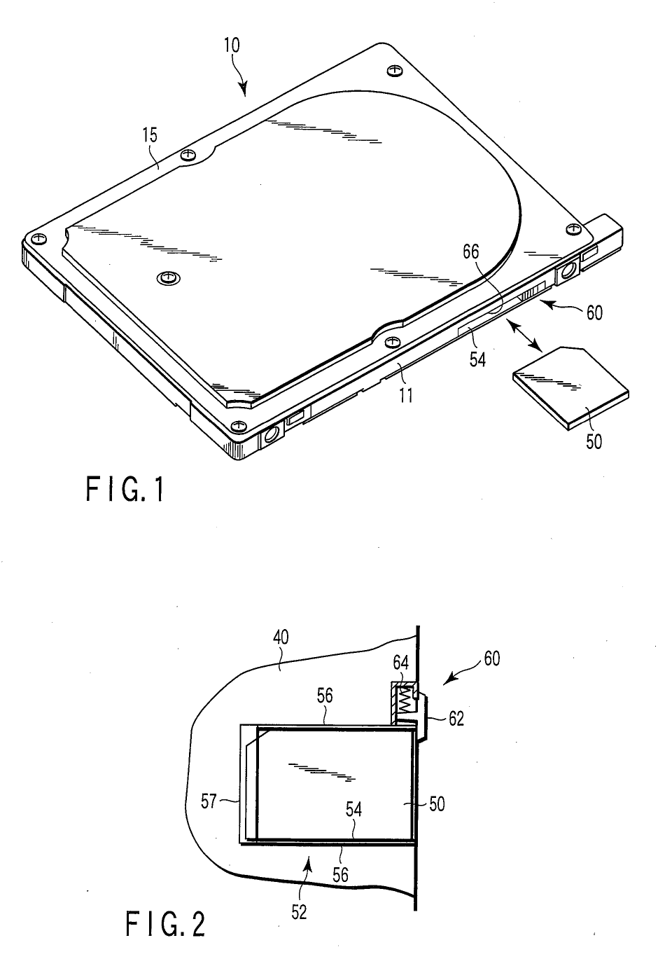

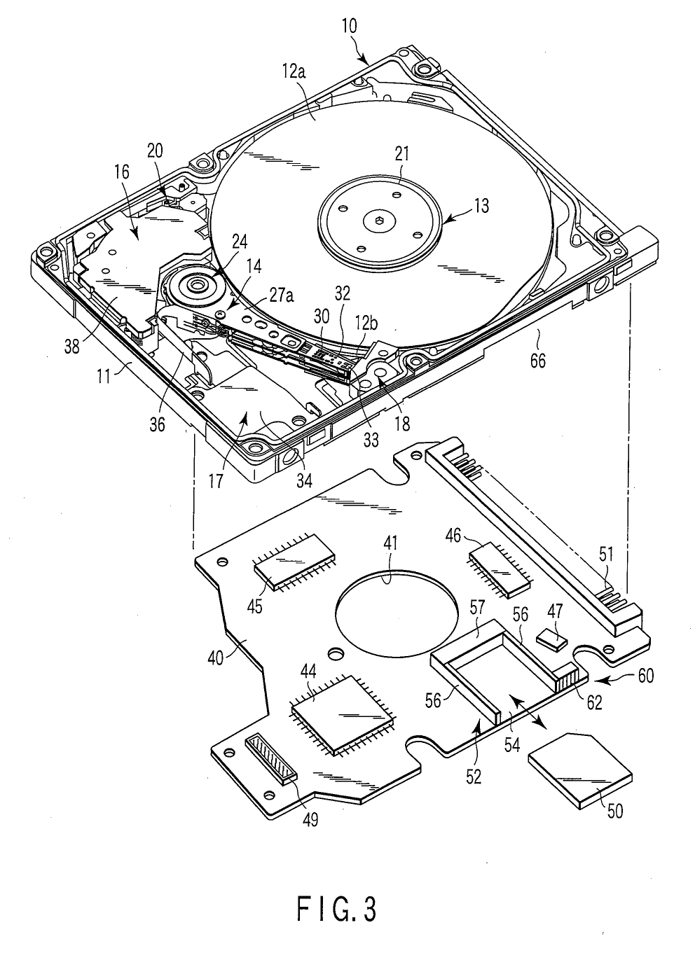

As shown in FIGS. 1 and 3, the HDD is provided with a housing 10 in the form of a flat rectangular box. The housing 10 includes a base 11 in the form of an open-topped rectangular box and a top cover 15 fastened to the base by screws so as to close a top opening of the base.

In the housing 10, the base 11 carries thereon two magnetic disks 12a and 12b for use as recording media, a spindle motor 13, magnetic heads 33, a head actuator 14, and a voice coil motor (VCM) 16. The spindle motor 13 supports and rotates the magnetic disks 12a and 12b. The magnetic heads 33 record and reproduce information to and from the magnetic disks 12a and 12b. The head actuator 14 supports the magnetic heads 33 for movement relative to the magnetic disks 12a and 12b. The VCM 16 serves to rotate and position the head actuator 14.

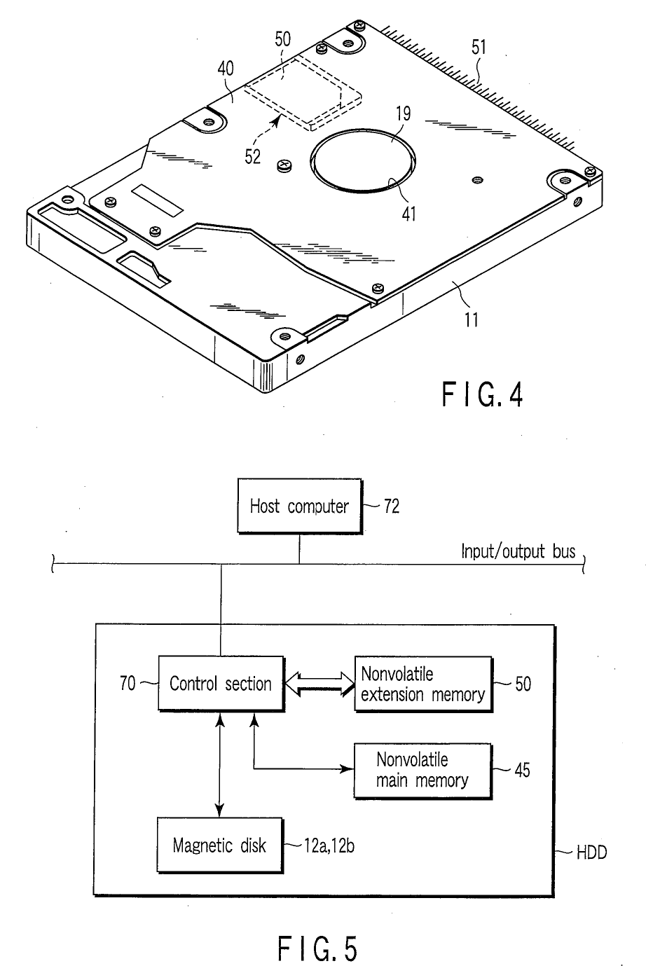

Further, the base 11 carries thereon a ramp load mechanism 18, an inertia latch mechanism 20, and a flexible printed circuit board unit (FPC unit) 17. The ramp load mechanism 18 holds the magnetic heads 33 in a position at a distance from the magnetic disks when the heads are moved to the outermost peripheries of disks. The inertia latch mechanism 20 serves to hold the head actuator 14 in a retracted position. Circuit components, including a preamplifier and the like, are mounted on the FPC unit 17. As shown in FIG. 4, the base 11 includes a bottom wall, and a circular columnar stator portion 19 of the spindle motor 13 protrudes from a substantially central part of the outer surface of the bottom wall.

As shown in FIG. 3, each of the magnetic disks 12a and 12b is formed having a diameter of, for example, 65 mm (2.5 inches) and provided with magnetic recording layers on its upper and lower surfaces, individually. The two magnetic disks 12a and 12b are coaxially fitted on a hub (not shown) of the spindle motor 13 and clamped by a clamp spring 21. They are spaced in layers in the axial direction of the hub. The magnetic disks 12a and 12b are rotated at a predetermined speed by the spindle motor 13 for use as a drive section.

The head actuator 14 is provided with a bearing assembly 24 fixed on the bottom wall of the base 11, four arms 27 attached to the bearing assembly, and four magnetic head assemblies 30 supported on the arms, individually. Each magnetic head assembly 30 is provided with an elongated suspension 32 formed of a leaf spring and the magnetic head 33 fixed to the suspension.

The VCM 16 includes a voice coil (not shown) attached to the head actuator 14, a yoke 38 fixed on the bottom wall of the base 11 so as to face the voice coil, and a magnet (not shown) fixed to the yoke.

The FPC unit 17 includes a rectangular board body 34 fixed on the base 11, and a plurality of electronic components, connectors, etc., are mounted on the board body. The FPC unit 17 includes a belt-shaped main flexible printed circuit board 36, which electrically connects the board body 34 and the head actuator 14. The magnetic heads 33 that are supported by the actuator 14 are electrically connected to the FPC unit 17 through a junction FPC (not shown) on the arms 27 and the main flexible printed circuit board 36.

As shown in FIGS. 2 and 4, a printed circuit board (PCB) 40 is screwed to the outer surface of the bottom wall of the base 11 so as to face the same. The PCB 40 causes the FPC unit 17 to control the operations of the spindle motor 13, VCM 16, and magnetic heads.

The PCB 40 is formed having a substantially rectangular shape corresponding to the base 11. A circular opening 41 through which the stator portion 19 of the spindle motor 13 is passed is formed in a substantially central part of the PCB 40. A large number of electronic components are mounted on the PCB 40. These electronic components include LSIs, such as a system LSI (SOC) 44 that serves as a control section 70, a nonvolatile main memory 45 with a memory capacity of, e.g., several GB, and a driver 46, a shock sensor 47, a lot of discrete components and chip components. Further, the PCB 40 is mounted with a connector 49 and a main connector 51. The connector 49 is connectable with a connector on the FPC unit 17 side. The main connector 51 is used to connect the HDD to a host computer, such as a personal computer.

As shown in FIGS. 2, 3 and 4, the PCB 40 carries thereon a memory slot 52 for use as a memory mounting section in which an expansion memory 50 (mentioned later) can be detachably mounted. The memory slot 52 includes an insertion port 54 that opens to the outside of the housing 10, a pair of guides 56 that are provided on the PCB 40 and extend from the insertion port 54, and a connector 57 on the respective proximal end portions of the guides.

The expansion memory 50 is formed as an SD card from a nonvolatile memory with a memory capacity of, e.g., several GB. The memory 50 is configured so that it can be loaded into and taken out of the memory slot 52 through the insertion port 54 from outside the housing 10.

When the PCB 40 is mounted on the outer surface of the housing 10, the stator portion 19 of the spindle motor 13 is situated in the opening 41 of the PCB, and the entire PCB is located without interfering with a bottom wall portion in which a lower yoke of the VCM 16 is embedded. The memory slot 52 is situated between the PCB 40 and the outer surface of the bottom wall of the base 11. Further, the slot 52 is provided in a position on the PCB 40 beside the stator portion 19 of the spindle motor 13 and opposite the magnetic disks 12a and 12b. The memory slot 52 is located in a position on the PCB 40 off the VCM 16 and the ramp load mechanism 18.

An elongated rectangular notch 66 is formed in the lower edge of a side wall of the base 11 that constitutes the housing 10. The insertion port 54 of the memory slot 52 is situated opposite the notch 66.

Provided on the PCB 40 is a locking mechanism 60 for restraining the expansion memory 50 from slipping out of the memory slot 52. The locking mechanism 60 is provided with a hook 62 and a spring 64. The hook 62 is movable to a projected position where it projects into the insertion port 54. The spring 64 urges the hook toward the projected position. The hook 62 is situated in the notch 66 of the base 11 so that it can be unlocked from outside the housing 10.

When the expansion memory 50 is mounted in the memory slot 52, as shown in FIG. 2, it is connected to the connector 57 and electrically connected to the PCB 40. Further, the hook 62 of the locking mechanism 60 is elastically held in the projected position, thereby restraining the expansion memory 50 from slipping out of the memory slot 52. The memory 50 can be removed from the slot 52 by being drawn out with the hook 62 moved to a position retracted from the insertion port 54.

FIG. 5 schematically shows a state in which the HDD is connected to a host computer 72 through the main connector 51. The expansion memory 50 that is mounted in the memory slot 52 is connected to the control section 70, which is connected to the host computer 72 by an input/output bus.

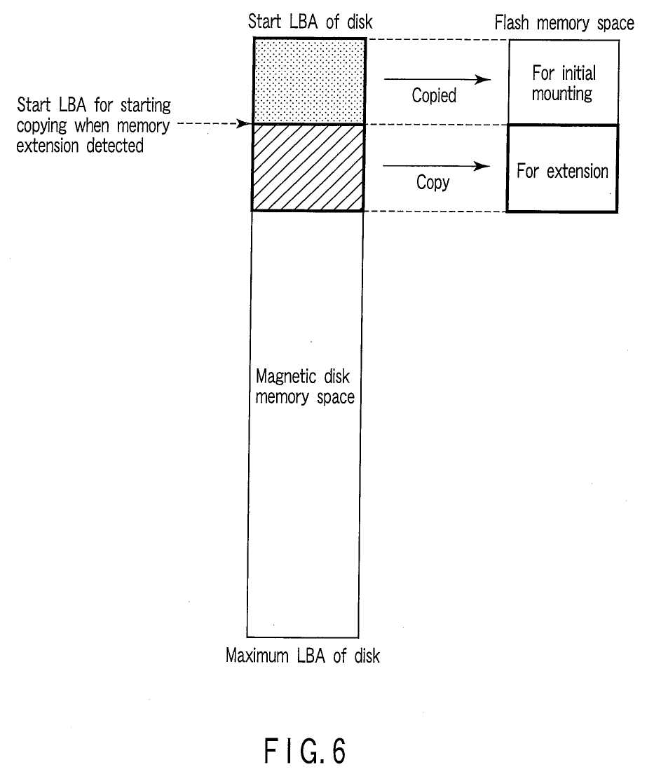

FIG. 6 typically shows the total memory capacity of the HDD. The total memory capacity includes the memory capacities (memory spaces) of the magnetic disks 12a and 12b and the memory capacity (flash memory space for initial implementation) of the nonvolatile main memory 45. If the expansion memory 50 is attached, a memory capacity for expansion is added. The amount of data equivalent to the memory capacity (flash memory space for initial implementation) of the nonvolatile main memory 45, among stored data of the magnetic disks 12a and 12b, is copied into the nonvolatile main memory. If the expansion memory 50 is attached, as described later, moreover, the amount of data equivalent to the memory capacity (flash memory space for extension) of the expansion memory 50, among the stored data of the magnetic disks 12a and 12b, is copied into the expansion memory. In FIG. 6, LBA designates a logical block address.

According to the HDD constructed in this manner, various data, including an operating system (OS) and the like, are recorded in recording regions (memory spaces) of the magnetic disks 12a and 12b. Further, the nonvolatile main memory 45 is loaded with some of data stored in the disks 12a and 12b, e.g., OS data and frequently used data. When the system of the host computer 72 is initialized, the control section 70 of the HDD reads data from the nonvolatile main memory 45 and starts an initiation sequence. When the host computer 72 enters a sleep state, the control section 70 loads the nonvolatile main memory 45 with the frequently used data and the like. When the computer 72 is returned from the sleep state, the control section 70 reads data from the nonvolatile main memory 45 and starts a sequence. Thus, when the host computer 72 is initialized or returned from the sleep state, the starting and recovery times can be shortened without rotating the magnetic disks 12a and 12b of the HDD. Specifically, a fast boot (data access during a time period from the stopped state of the spindle motor to the completion of initiation) can be obtained. Further, the power consumption can be reduced in order to omit the initiation of rotation of the magnetic disks. Furthermore, the response speed and shock resistance can be improved by exchanging data from the nonvolatile main memory 45 in the HDD without rotating the magnetic disks.

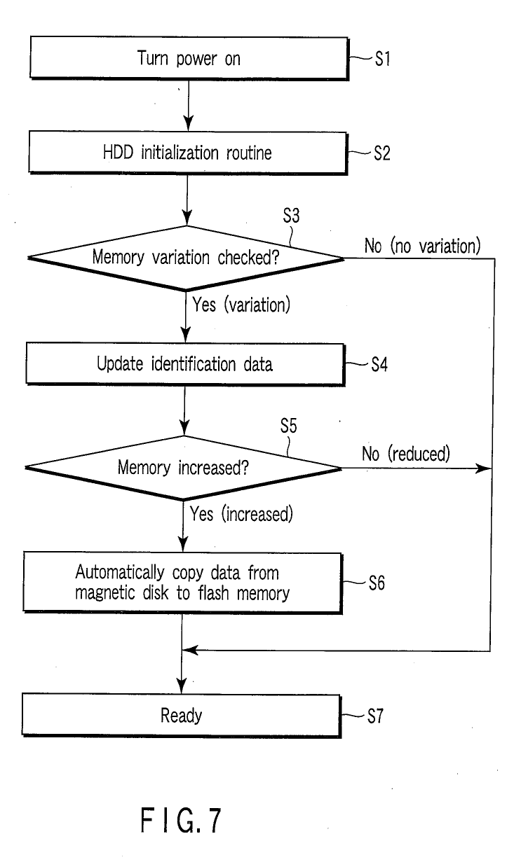

If the expansion memory 50 is mounted in the memory slot 52, moreover, the control section 70 detects this and recognizes an increase of the capacity of a cache memory. When the power of the HDD is turned on through the host computer 72 (S1), as shown in FIG. 7, the control section 70 executes an initialization routine for the HDD (S2). Subsequently, the control section 70 detects a variation of the memory capacity (S3). If the memory capacity is increased or reduced, the control section 70 updates identification data (S4). It is assumed that the expansion memory 50 for function extension is previously loaded with information that is indicative of its own memory capacity. In response to a memory capacity notification request from the control section 70 of the HDD, the expansion memory 50 returns its own memory capacity. Further, the HDD notifies the host computer 72 of the extended memory capacity as identification information, besides the memory capacities of the magnetic disks 12a and 12b. When a nonvolatile memory is provided for expansion, therefore, the control section 70 updates capacity information on the memory contained in the HDD.

Subsequently, the control section 70 determines whether or not the memory capacity is increased, that is, whether or not the expansion memory 50 is attached (S5). If the memory capacity is increased, the control section 70 copies an amount of data equivalent to the memory capacity of the expansion memory 50, among the data recorded in the magnetic disks 12a and 12b, into the memory 50 (S6), thereby establishing a ready state (S7). In this automatic copying operation, as shown in FIG. 6, the control section 70 starts reading data form the magnetic disk at a corresponding starting address on each magnetic disk with a data capacity equivalent to the extended memory capacity and copies it into the expansion memory 50.

Thereafter, the HDD reads data from the expansion memory 50 as the data concerned is read from the host computer 72. In writing data, the data are recorded to the expansion memory 50 and the magnetic disks 12a and 12b by parallel processing.

In order to maximize the aforementioned fast boot, it is to be desired that a defragmentation program for the magnetic disks 12a and 12b be executed once before the expansion memory 50 is provided for extension so that data of higher use frequencies can be located in start LBAs of the HDD.

According to the HDD constructed in this manner, the memory capacity can be easily increased at low cost at user's option. With the addition of the nonvolatile memory, the volume of data loaded from the magnetic disks into the nonvolatile memory increases, so that the fast boot can be prompted. At the same time, reduction of the power consumption, improvement of the response speed, and enhancement of the shock resistance can be expedited.

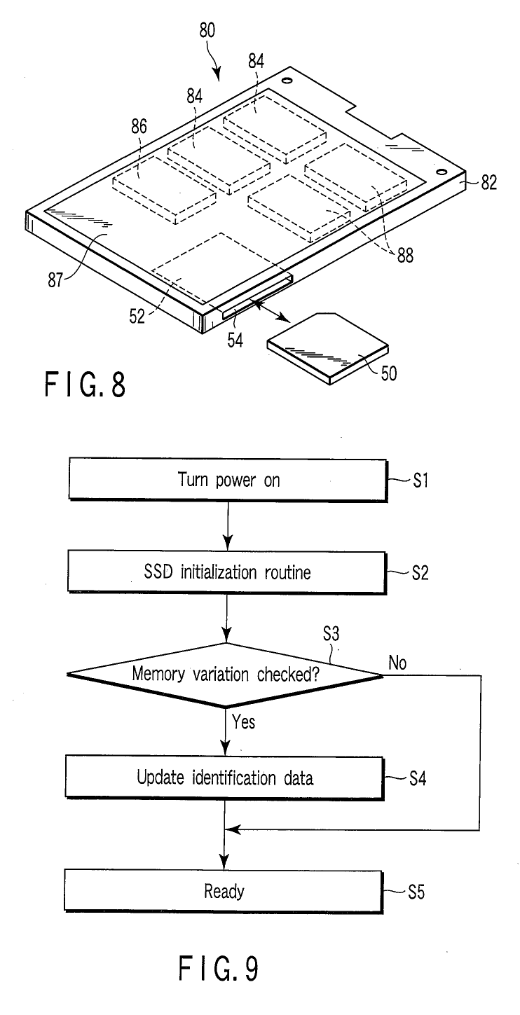

The following is a description of an SSD according to a second embodiment of this invention. As shown in FIG. 8, an SSD 80 is provided with a housing 82 in the form of a flat rectangular box, and a circuit board 87 is disposed in the housing. A plurality of nonvolatile memories 84 and 88 with memory capacities of, for example, several GB are mounted on the circuit board 87. Further, the circuit board 87 carries thereon a system LSI that serves as a control section 86, connectors (not shown) for connection with a host computer, such as a personal computer, etc.

In the housing 82, the circuit board 87 carries thereon a memory slot 52 for use as a memory mounting section in which an expansion memory 50 can be removably mounted. The memory slot 52 includes an insertion port 54 that opens in a side surface of the housing 82, a pair of guides (not shown) that are provided on the circuit board and extend from the insertion port 54, and a connector on the respective proximal end portions of the guides. The expansion memory 50 is formed as an SD card from a nonvolatile memory with a memory capacity of, e.g., several GB. The memory 50 is configured so that it can be loaded into and taken out of the memory slot 52 through the insertion port 54 from outside the housing 82.

If the expansion memory 50 is mounted in the memory slot 52 in the SSD 80, the control section 86 detects this and recognizes an increase of the capacity of a cache memory. When the power of the SSD is turned on through the host computer (S1), as shown in FIG. 9, the control section 86 executes an initialization routine for the SSD (S2). Subsequently, the control section 86 determines whether or not the memory capacity is increased, that is, whether or not the expansion memory 50 is attached (S3). It is assumed that the expansion memory 50 for function extension is previously loaded with information that is indicative of its own memory capacity. In response to a memory capacity notification request from the control section 86, the expansion memory 50 returns its own memory capacity.

If the memory capacity is increased, the control section 86 updates identification data (S4). The SSD 80 notifies the host computer of the extended memory capacity as identification information. When a nonvolatile memory is provided for extension, therefore, the control section 86 updates capacity information on the memory contained in the SSD. After this is done, the SSD 80 establishes a ready state (S5).

Thereafter, the SSD 80 reads data from the nonvolatile memories 84 and 88 and the expansion memory 50 as the data is read from the host computer. In writing data, the data are recorded to the memories 84 and 88 and the memory 50 by parallel processing.

According to the SSD constructed in this manner, the memory capacity can be easily increased at low cost at user's option. If any part of a built-in nonvolatile memory breaks down, moreover, recovering the original capacity can be easily performed by mounting the expansion memory in place.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention.

The accompanying claims and their equivalents are intended to cover such forms or modifications as would fall within the scope and spirit of the invention.

For example, the capacity of the expansion memory may be varied as required without being limited to the embodiments described herein. The expansion memory is not limited to an SD card, but may alternatively be a mini-SD card, micro SD card, or memory stick version. Interface specifications of the expansion memory, such as its bus width, transfer rate, etc., need not comply with those of the existing memory media, but are expected only to fulfill the aforementioned functions. Further, the memory mounting section is not limited to one in number, but a plurality of extension memories can be mounted for extension if a plurality of memory mounting sections are provided. Furthermore, this invention is not limited to hybrid HDDs and SSDs, but may also be applicable to other information processing apparatuses.

1. An information processing apparatus comprising:
a disk-shaped recording medium;
a drive section which rotates the recording medium;
a head which records and reproduces information to and from the recording medium;
a nonvolatile main memory which stores data in the recording medium;
a memory mounting section in which a nonvolatile expansion memory is detachably mountable from outside; and
a control section which reads data equivalent to a memory capacity of the expansion memory from the recording medium and writes the data to the expansion memory when the expansion memory is mounted in the memory mounting section.

2. The information processing apparatus according to claim 1, wherein the control section is provided with a section which detects an increase of the memory capacity, notifies a host machine of the respective memory capacities of the recording medium, the nonvolatile main memory, and the expansion memory as identification information, and updates capacity information on the nonvolatile memory and the expansion memory when the expansion memory is mounted in the memory mounting section.

3. The information processing apparatus according to claim 1, wherein the control section is provided with a section which starts reading data from the recording medium at a starting address on the recording medium with a capacity equivalent to the memory capacity of the expansion memory and copies the read data into the expansion memory, in writing to the expansion memory.

4. An information processing apparatus comprising:
a housing;
a nonvolatile main memory provided in the housing;
a memory mounting section which has an insertion port opening in an outer surface of the housing and in which a nonvolatile expansion memory is detachably mountable from the outside of the housing; and
a control section which is provided in the housing, performs information processing based on data supplied from the nonvolatile main memory, and performs information processing based on data supplied from the nonvolatile main memory and the expansion memory when the expansion memory is mounted in the memory mounting section.

5. The information processing apparatus according to claim 4, wherein the control section is provided with a section which detects an increase of the memory capacity, notifies a host machine of the respective memory capacities of the nonvolatile main memory and the expansion memory as identification information, and updates capacity information on the nonvolatile memory and the expansion memory when the expansion memory is mounted in the memory mounting section.

6. An information processing apparatus comprising:
a housing;
a disk-shaped recording medium provided in the housing;
a spindle motor which is arranged in the housing and supports and rotates the recording medium;
a head which records and reproduces information to and from the recording medium;
a head actuator which is provided in the housing, supports the head for movement, and moves the head with respect to the recording medium;
a circuit board opposed to an outer surface of the housing; and
a memory mounting section provided on the circuit board and in which a nonvolatile expansion memory is detachably mountable from an outside of the housing.

7. The information processing apparatus according to claim 6, wherein the memory mounting section is provided in a position on the circuit board beside the spindle motor and opposite the recording medium.

8. The information processing apparatus according to claim 7, wherein the memory mounting section includes a memory slot which is provided on the circuit board and has an insertion port opening to the outside of the housing.

9. The information processing apparatus according to claim 8, which further comprises a voice coil motor which is provided in the housing and drives the head actuator, and wherein the memory mounting section is provided in a position on the circuit board off the voice coil motor.

10. The information processing apparatus according to claim 6, which further comprises a locking mechanism which is provided on the circuit board and restrains the expansion memory from slipping out of the memory mounting section.

11. The information processing apparatus according to claim 6, which further comprises a control section which reads data equivalent to a memory capacity of the expansion memory from the recording medium and writes the data to the expansion memory when the expansion memory is mounted in the memory mounting section.
